(19) United States
(12) Patent Application Publication
(10) Pub. No.: US 2025/0284158 A1
(43) Pub. Date: Sep. 11, 2025

(54) OPTICAL SYSTEM

(71) Applicant: Japan Display Inc., Tokyo (JP)

(72) Inventor: Toshiharu MATSUSHIMA, Tokyo (JP)

(21) Appl. No.: 19/024,631

(22) Filed: Jan. 16, 2025

(30) Foreign Application Priority Data
Mar. 11, 2024 (JP) 2024-037452

(51) Int. Cl. G02F 1/1335; G02F 1/13357

(52) U.S. Cl. CPC G02F 1/133512; G02F 1/133531; G02F 1/133603; G02F 1/13362

(57) ABSTRACT

Disclosed is an optical system including a display device, an optical element, and an optical shutter. The optical element is located over the display device and is configured to transmit light from the display device. The optical shutter is located over the optical element. The optical element is further configured to maintain a polarization axis of the light in a driving state and rotate the polarization axis of the light by 90° in a non-driving state. The optical shutter has a pair of linear polarizers with transmission axes intersecting each other.

### CROSS-REFERENCE TO RELATED APPLICATIONS

This application claims the benefit of priority to Japanese Patent Application No. 2024-037452, filed on Mar. 11, 2024, the entire contents of which are incorporated herein by reference.

### FIELD

An embodiment of the present invention relates to an optical system having an image-displaying function. For example, an embodiment of the present invention relates to an optical system capable of capturing an image created with light having different polarization states and allowing the image to be viewed.

### BACKGROUND

An in-vehicle display device in which a TN (Twisted Nematic) liquid crystal element is arranged on a liquid crystal display has been known (Japanese laid-open patent publication No. 2006-208606). Since the polarization axis of the light from the liquid crystal display device can be rotated by the TN liquid crystal element in this display device, it is possible to change the polarization axis of the light forming an image by appropriately driving the TN liquid crystal element. As a result, the use of the difference in reflection characteristics between light with different polarization axes not only prevents the reflection of images on reflective surfaces such as windshields but also allows images to be displayed on the reflective surfaces by utilizing the reflection.

### SUMMARY

An embodiment of the present invention is an optical system. The optical system includes a display device, an optical element, and an optical shutter. The optical element is located over the display device and is configured to transmit light from the display device. The optical shutter is located over the optical element. The optical element is further configured to maintain a polarization axis of the light in a driving state and rotate the polarization axis of the light by 90° in a non-driving state. The optical shutter has a pair of linear polarizers with transmission axes intersecting each other.

### BRIEF DESCRIPTION OF DRAWINGS

FIG. 1 is a schematic developed perspective view of an optical system according to an embodiment of the present invention.

FIG. 2 is a schematic top view of a display device of an optical system according to an embodiment of the present invention.

FIG. 3 is a schematic cross-sectional view of a portion of an optical system according to an embodiment of the present invention.

FIG. 4 is a schematic side view of an optical system according to an embodiment of the present invention.

FIG. 5 is a schematic perspective view for explaining an operation of an optical system according to an embodiment of the present invention.

FIG. 6 is a schematic perspective view for explaining an operation of an optical system according to an embodiment of the present invention.

FIG. 7 is a schematic perspective view for explaining an operation of an optical system according to an embodiment of the present invention.

FIG. 8 is a schematic perspective view for explaining an operation of an optical system according to an embodiment of the present invention.

FIG. 9 is a schematic perspective view for explaining an operation of an optical system according to an embodiment of the present invention.

FIG. 10 is a schematic view for explaining an operation of an optical system according to an embodiment of the present invention.

FIG. 11 is a schematic view for explaining an operation of an optical system according to an embodiment of the present invention.

FIG. 12 is a schematic side view for explaining an operation of an optical system according to an embodiment of the present invention.

FIG. 13 is a schematic side view for explaining an operation of an optical system according to an embodiment of the present invention.

FIG. 14 is a schematic cross-sectional view of a portion of an optical system according to an embodiment of the present invention.

FIG. 15 is a schematic cross-sectional view of a portion of an optical system according to an embodiment of the present invention.

FIG. 16 is a schematic cross-sectional view of a portion of an optical system according to an embodiment of the present invention.

FIG. 17 is a schematic cross-sectional view of a portion of an optical system according to an embodiment of the present invention.

FIG. 18 is a schematic cross-sectional view of a portion of an optical system according to an embodiment of the present invention.

FIG. 19 is a schematic cross-sectional view of a portion of an optical system according to an embodiment of the present invention.

FIG. 20 is a schematic cross-sectional view of a portion of an optical system according to an embodiment of the present invention.

FIG. 21 is a schematic cross-sectional view of a portion of an optical system according to an embodiment of the present invention.

FIG. 22 is a schematic cross-sectional view of a portion of an optical system according to an embodiment of the present invention.

FIG. 23 is a schematic cross-sectional view of a portion of an optical system according to an embodiment of the present invention.

FIG. 24 is a schematic cross-sectional view of a portion of an optical system according to an embodiment of the present invention.

FIG. 25 is a schematic cross-sectional view of a portion of an optical system according to an embodiment of the present invention.

### DESCRIPTION OF EMBODIMENTS

Hereinafter, each embodiment of the present invention is explained with reference to the drawings. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention. In the specification and the drawings, the same reference number is provided to an element that is the same as that which appears in preceding drawings, and a detailed explanation may be omitted as appropriate. The reference number is used when plural structures which are the same as or similar to each other are collectively represented, while a hyphen and a natural number are further used when these structures are independently represented.

In the specification and the claims, unless specifically stated, when a state is expressed where a structure is arranged “over” another structure, such an expression includes both a case where the substrate is arranged immediately above the “other structure” so as to be in contact with the “other structure” and a case where the structure is arranged over the “other structure” with an additional structure therebetween.

In the specification and the claims, an expression that two structures “orthogonally intersect” or “are perpendicular to each other” includes not only a state where the two structures intersect each other at 90° but also a state where the two structures intersect each other at an angle of 90°±10°. An expression that “two structures are parallel” includes a state where an angle between extending directions of the two structures is 0°±10°.

### First Embodiment

In this embodiment, an optical system according to an embodiment of the present invention is explained.

### 1. Structure

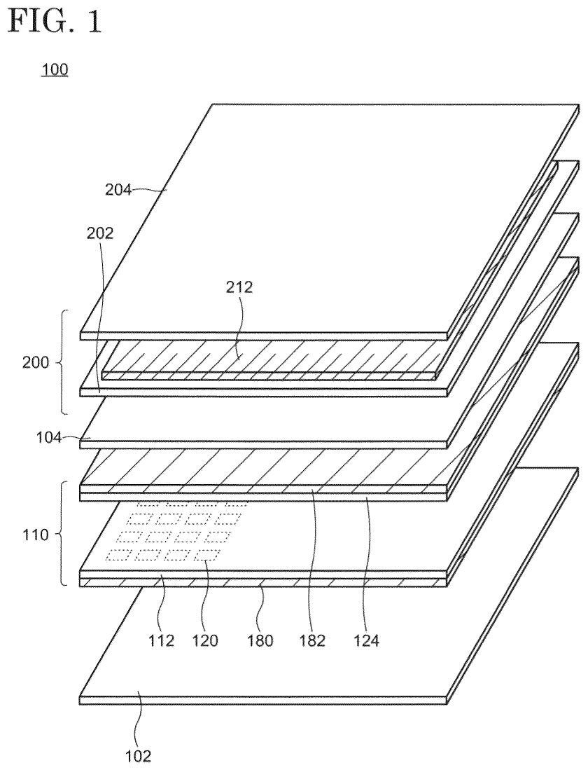

FIG. 1 is a schematic developed perspective view of an optical system 100 according to an embodiment of the present invention. As shown in FIG. 1, the optical system 100 includes a display device 110 and an optical element 200 provided over the display device 110 and overlapping the display device 110. As described below in detail, a backlight 102 is further provided when the display device 110 includes a liquid crystal element. Note that, although the components such as the display device 110, the optical element 200, and the backlight 102 are separately illustrated in FIG. 1, these components are fixed to one another directly or by means of adhesive layers, fixing jigs, housings, and the like. For example, the display device 110 and the optical element 200 may be fixed to each other with an adhesive layer 104 containing a polymer such as an epoxy resin and an acrylic resin. Although not illustrated in FIG. 1, the optical system 100 further includes an optical shutter as described below.

### (1) Backlight

The backlight 102 is a light source for irradiating the optical system 100 with light. Since a known structure can be employed for the backlight 102, a detailed description is omitted. Briefly, the backlight 102 has a cold cathode tube and/or a light-emitting diode (LED) serving as a light source and is composed of a reflector for effective use of the light from the light source, a light diffuser for uniformly diffusing the light, a light guide plate, a prism sheet, and the like. The light from the backlight 102 is incident on the optical element 200 through the display device 110.

### (2) Display Device

As the display device 110, a liquid crystal display device and an electroluminescence display device can be utilized. The display device 110 may be an active-matrix type display device or a passive-matrix type display device. As an example, an active-matrix type liquid crystal display device is used as the display device 110 in this embodiment.

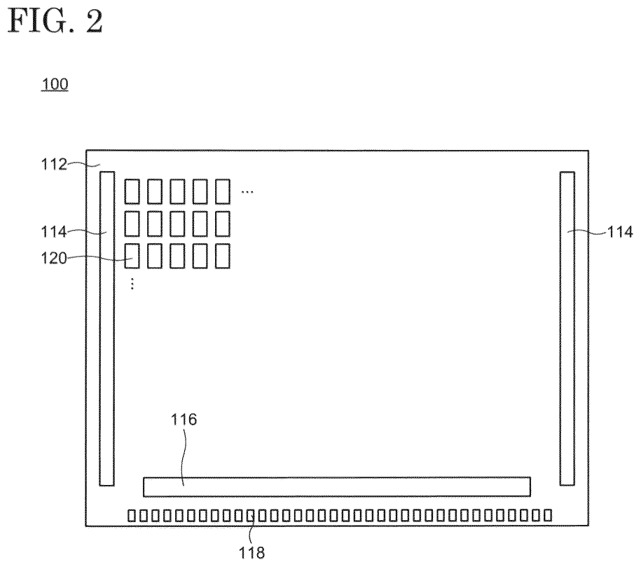

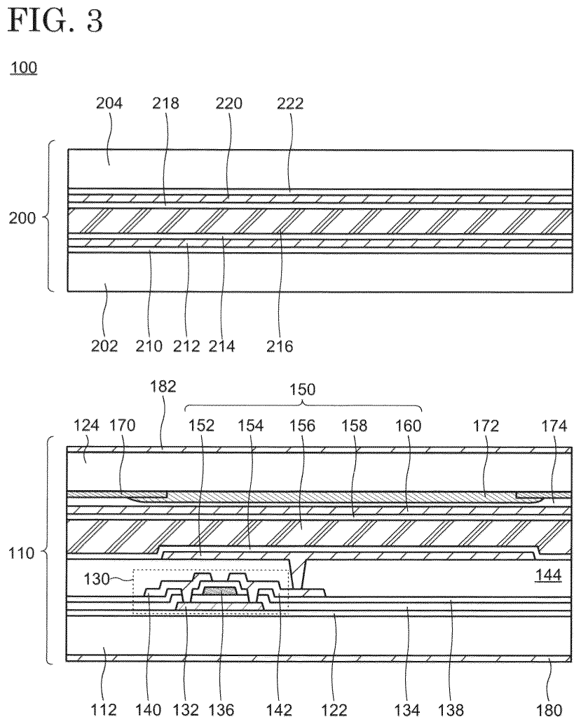

FIG. 2 shows a schematic top view of the display device 110, and FIG. 3 shows a schematic cross-sectional view of the optical system 100 excluding the optical shutter. As shown in these drawings, the display device 110 has a substrate 112 and a counter substrate 124 opposing the substrate 112. The substrate 112 and the counter substrate 124 are components for transmitting the light from the display device 110 and for providing mechanical strength to the display device 110. Accordingly, both the substrate 112 and the counter substrate 124 are configured to transmit visible light and include glass or a resin such as a polyimide and a polycarbonate. The substrate 112 and the counter substrate 124 may be flexible.

A variety of patterned insulating films, conductive films, and semiconductor films are stacked between the substrate 112 and the counter substrate 124. These films constitute pixels 120, driver circuits (scanning-line driver circuit 114 and signal-line driver circuit 116), and terminals 118 as well as pixel circuits including a transistor 130. Electric power and a variety of signals are input from an external circuit, which is not illustrated, through the terminals 118, and control signals (gate signals, initialization signals, video signals, and so on) for displaying images are generated by the driver circuits and are supplied to the pixels 120. Control of the pixels with the control signals allows the display device 100 to display images.

There is no restriction on the structure of the pixel circuit, and the pixel circuit is composed of a plurality of transistors including the transistor 130 and one or a plurality of capacitance elements which are not illustrated. In the example shown here, the transistor 130 is provided over an undercoat 122, which is an inorganic insulating film, and is composed of a semiconductor film 132, a gate insulating film 134, a gate electrode 136, an interlayer insulating film 138, a pair of terminals 140 and 142, and the like. The configuration of the transistor 130 can also be arbitrarily determined, and the transistor 130 may be a top-gate type transistor shown in FIG. 3, a bottom-gate type transistor, or the like. A leveling film 144 is provided over the pixel circuits to absorb the unevenness thereof.

The display device 110 further includes a liquid crystal element 150 over the leveling film 144. The liquid crystal element 150 shown in FIG. 3 is a so-called TN liquid crystal element and is composed of a pixel electrode 152 electrically connected to the transistor 130, a first orientation film 154 over the pixel electrode 152, a liquid crystal layer 156 over the first orientation film 154, a second orientation film 158 over the liquid crystal layer 156, a common electrode 160 to which a common potential is applied, and the like. Over the common electrode 160, a color filter 172 overlapping the pixel electrode 152 through an overcoat 174, which is an optional component, and a black matrix 170 for preventing light leakage between adjacent pixels 120 are provided. These configurations allow the pixel 120 to function as the smallest unit providing color information. Although not illustrated, the liquid crystal element 150 is not limited to a TN liquid crystal element, and a VA (Vertical Alignment) liquid crystal element or an IPS (In-Plane Switching) liquid crystal element may be utilized.

The first orientation film 154 and the second orientation film 158 include a resin such as a polyimide and are configured to orient liquid crystal molecules included in the liquid crystal layer 156 in a certain direction. Hence, the first orientation film 154 and the second orientation film 158 are subjected to an alignment process such as a rubbing process or are formed using photo-alignment. The directions in which the first orientation film 154 and the second orientation film 158 respectively orient the liquid crystal molecules (which is the direction of the long axis of the liquid crystal molecules when they are oriented under the influence of the orientation film, and is, hereinafter, referred to as an orientation direction) are orthogonal to each other.

The display device 110 is further provided with a first linear polarizer 180 under the substrate 112 and a second linear polarizer 182 over the counter substrate 124. The first linear polarizer 180 and the second linear polarizer 182 are arranged to exist in a crossed Nicols relationship with each other. Accordingly, the light from the backlight 102 becomes linearly polarized light (e.g., P-polarized light) when passing through the first linear polarizer 180. When the liquid crystal element 150 is a TN liquid crystal element, this linearly polarized light is optically rotated by 90° by the liquid crystal layer 156 to become linearly polarized light (e.g., S-polarized light) and passes through the second linear polarizer 182 when the display device 110 is not driven. Therefore, the linearly polarized light is incident on the optical element 200.

The transmission axis of the first linear polarizer 180 may be parallel to a side of the substrate 112 or may be inclined from a side of the substrate 112. In the latter case, it is preferable to provide the first linear polarizer 180 so that the transmission axis of the first linear polarizer 180 is inclined 45° with respect to a side of the substrate 112. Since the first linear polarizer 180 and the second linear polarizer 182 are in a crossed Nicols relationship as described above, when the transmission axis of the first linear polarizer 180 is parallel to a side of the substrate 112, the transmission axis of the second linear polarizer 182 is perpendicular to this side. On the other hand, when the transmission axis of the first linear polarizer 180 is inclined with respect to a side of the substrate 112, the transmission axis of the second linear polarizer 182 is also inclined at the same angle with respect to this side.

### (3) Optical Element

The optical element 200 is a component for transmitting the light emitted from the display device 110 and for controlling the polarization axis thereof and includes a TN liquid crystal element. Specifically, as shown in FIG. 1 and FIG. 3, the optical element 200 has a substrate 202 and a counter substrate 204 opposing the substrate 202. Similar to the substrate 112 and the counter substrate 124, the substrate 202 and the counter substrate 204 are configured to transmit the light from the display device 110 and to provide mechanical strength to the optical element 200. Therefore, the substrate 202 and the counter substrate 204 are also configured to transmit visible light and include glass or a resin such as a polyimide and a polycarbonate. The substrate 202 and/or the counter substrate 204 may also be flexible.

A first electrode 212, a third orientation film 214 over the first electrode 212, a liquid crystal layer 216 over the third orientation film 214, a fourth orientation film 218 over the liquid crystal layer 216, and a second electrode 220 over the fourth orientation film 218 are provided between the substrate 202 and the counter substrate 204. The TN liquid crystal element is composed of the first electrode 212, the third orientation film 214, the liquid crystal layer 216, the fourth orientation film 218, and the second electrode 220. As an optional component, the optical element 200 may have a protective insulating film 210 and/or a protective insulating film 222 between the substrate 202 and the first electrode 212 and between the counter substrate 204 and the second electrode 220, respectively. The protective insulating films 210 and 222 may be composed of one or a plurality of films containing a silicon-containing inorganic compound such as silicon nitride and silicon oxide. It is possible to prevent impurities contained in the substrate 202 and the counter substrate 204, such as alkali metals, from entering the liquid crystal layer 216 by the protective insulating films 210 and 222.

Both the first electrode 212 and the second electrode 220 are configured to transmit visible light. Therefore, the first electrode 212 and the second electrode 220 preferably include a conductive oxide transmitting visible light, such as indium-tin oxide (ITO) and indium-zinc oxide (IZO). The first electrode 212 and the second electrode 220 may each be formed as a single conductive film, or, although not illustrated, may be composed of a plurality of conductive films arranged in a stripe form. For example, one of the first electrode 212 and the second electrode 220 may be formed as a single conductive film overlapping all of the pixels 120, and the other may be formed as a plurality of conductive films arranged in a stripe form.

Similar to the first orientation film 154 and the second orientation film 158, the third orientation film 214 and the fourth orientation film 218 also contain a resin such as a polyimide and are configured to orient nematic liquid crystal molecules included in the liquid crystal layer 216 in a certain direction. Therefore, the third orientation film 214 and the fourth orientation film 218 are subjected to an alignment process such as a rubbing process or are formed by using photo-alignment. The orientation directions of the third orientation film 214 and the fourth orientation film 218 are also orthogonal to each other. Furthermore, the third orientation film 214 is preferably provided so that the orientation direction is parallel to the transmission axis of the second linear polarizer 182. As described below, arrangement of the optical element 200 with such a configuration allows the polarization axis of the linearly polarized light incident on the optical element 200 from the display device 110 to be rotated by 90° by the liquid crystal layer 216 when the optical element 200 is not driven and to be maintained when the optical element 200 is driven.

In the optical system 100 having the aforementioned configuration, it is not necessary to arrange any polarizer in the optical element 200. Therefore, the adhesive layer 104 securing the display device 110 and the optical element 200 to each other may be in direct contact with the second linear polarizer 182 and the substrate 202. In addition, the counter substrate 204 may be directly exposed to the outside air.

### (4) Optical Shutter

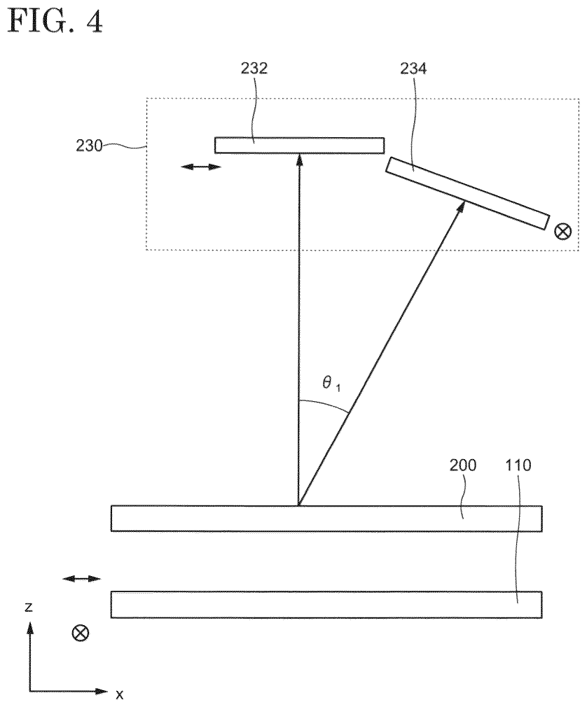

As shown in FIG. 4, the optical system 100 has an optical shutter 230 over the optical element 200. The optical shutter 230 includes a pair of linear polarizers 232 and 234 with transmission axes orthogonal to each other. In order to distinguish the polarizers 232 and 234 from the first linear polarizer 180 and the second linear polarizer 182, the linear polarizers 232 and 234 are hereinafter referred to as the polarizers for optical selection 232 and 234, respectively. The polarizer for optical selection 232 is positioned parallel to the display device 110. That is, the polarizer for optical selection 232 is provided so that the main surface thereof is orthogonal to the normal of the main surface of the display device 110 (e.g., the main surface of the substrate 112). On the other hand, the other polarizer for optical selection 234 is arranged so as to be inclined with respect to the display device 110. Specifically, the polarizer for optical selection 234 is provided so that the normal of the main surface thereof is inclined from the normal of the main surface of the display device 110 at a polar angle θ₁. The polar angle θ₁ is, for example, 20°±5°.

Furthermore, the optical shutter 230 is configured to selectively or preferentially transmit the light emitted from the optical element 200 through one of the polarizers for optical selection 232 and 234 when the optical element 200 is driven and to selectively or preferentially transmit this light through the other of the polarizers for optical selection 232 and 234 when the optical element 200 is not driven. For example, the polarizer for optical selection 232 is arranged so that its transmission axis (see the straight arrow in the drawing) is parallel to the polarization axis of the light emitted from the optical element 200 when the optical element 200 is not driven. In the optical system 100 having the aforementioned configuration, since the light is optically rotated by 90° by the optical element 200 in the non-driving state, the polarization axis of the light, which is emitted from the optical element 200 and is incident on the polarizer for optical selection 232 when the optical element 200 is not driven, is perpendicular to the transmission axis of the second linear polarizer 182. Therefore, the polarizer for optical selection 232 is arranged so that its transmission axis is parallel to the transmission axis of the second linear polarizer 182. On the other hand, since the transmission axis of the polarizer for optical selection 234 is orthogonal to that of the polarizer for optical selection 232, the polarizer for optical selection 234 is arranged so that its transmission axis is perpendicular to the transmission axis of the second linear polarizer 182. With this configuration, when the optical element 200 is not driven, the image displayed by the display device 110 can be selectively or preferentially acquired through the polarizer for optical selection 234. In contrast, when the optical element 200 is driven, the polarization axis of the light incident on the optical element 200 is maintained so that an image can be selectively or preferentially acquired through the polarizer for optical selection 232.

Conversely, the optical system 100 may be configured so that an image is acquired through the polarizer for optical selection 232 when the optical element 200 is not driven and so that an image is acquired through the polarizer for optical selection 234 when the optical element 200 is driven. In this case, the polarizer for optical selection 232 may be arranged so that its transmission axis is parallel to the polarization axis of the light emitted from the optical element 200 when the optical element 200 is not driven. That is, the polarizer for optical selection 232 may be arranged so that its transmission axis is perpendicular to the transmission axis of the second linear polarizer 182. Conversely, since the transmission axis of the polarizer for optical selection 234 is orthogonal to that of the polarizer for optical selection 232, the polarizer for optical selection 234 is arranged so that its transmission axis is parallel to the transmission axis of the second linear polarizer 182. Hence, it is possible to view and acquire images formed by the light with different polarization states by using the optical system 100 having the above configuration.

### 2. Optical Control by Optical System

As described above, the optical element 200 disposed over the display device 110 is a TN liquid crystal element. Therefore, when the optical element 200 is not driven, that is, when no potential difference is provided between the first electrode 212 and the second electrode 220, the liquid crystal molecules are oriented according to the orientation directions of the third orientation film 214 and the fourth orientation film 218. Specifically, the liquid crystal molecules are oriented along the orientation direction of the third orientation film 214 on the first electrode 212 side and along the orientation direction of the fourth orientation film 218 on the second electrode 220 side. Since the orientation directions of the third orientation film 214 and the fourth orientation film 218 are orthogonal to each other, the orientation direction of the liquid crystal molecules twists as they approach the second electrode 220 from the first electrode 212, eventually twisting by 90°. Accordingly, the light incident on the optical element 200 optically rotates by 90° within the liquid crystal layer 216. In contrast, when the optical element 200 is driven, that is, when a potential difference is provided between the first electrode 212 and the second electrode 220 to generate a sufficient longitudinal electric field therebetween, the liquid crystal molecules are oriented in the direction of the electric field, i.e., in the direction perpendicular to the first electrode 212. In this case, the light incident on the optical element 200 does not optically rotate, and the polarization axis is maintained.

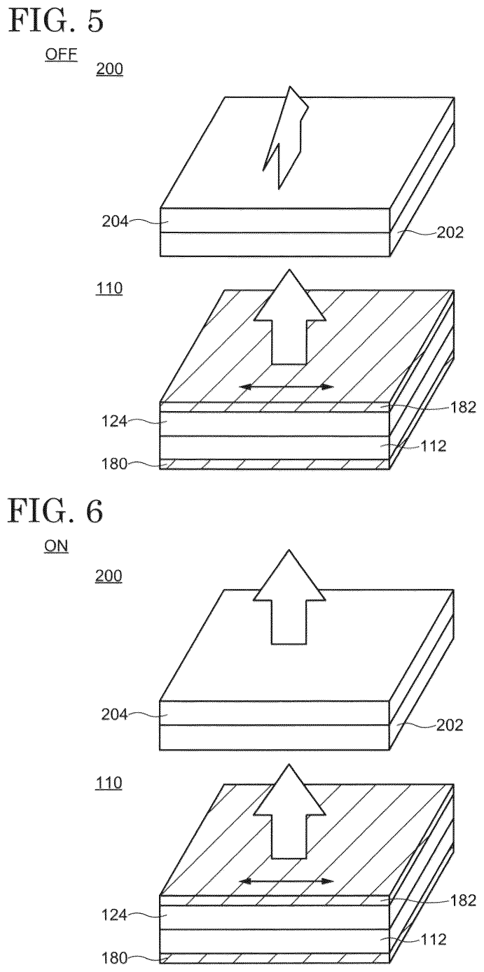

When the transmission axis of the second linear polarizer 182 is parallel to a side of the substrate 112, the polarization axis of the light emitted from the display device 110 (white arrow in the drawing) is parallel to the transmission axis of the second linear polarizer 182 (solid arrow) as shown in FIG. 5. When the optical element 200 is not driven (OFF), the polarization axis of the light emitted from the optical element 200 becomes perpendicular to the transmission axis of the second linear polarizer 182 since the polarization axis of the incident light is rotated by 90° by the optical element 200. On the other hand, when the optical element 200 is driven (ON), the polarization axis of the light emitted from optical element 200 becomes parallel to the transmission axis of the second linear polarizer 182 (see white arrow in FIG. 6) because the polarization axis of the incident light is not rotated.

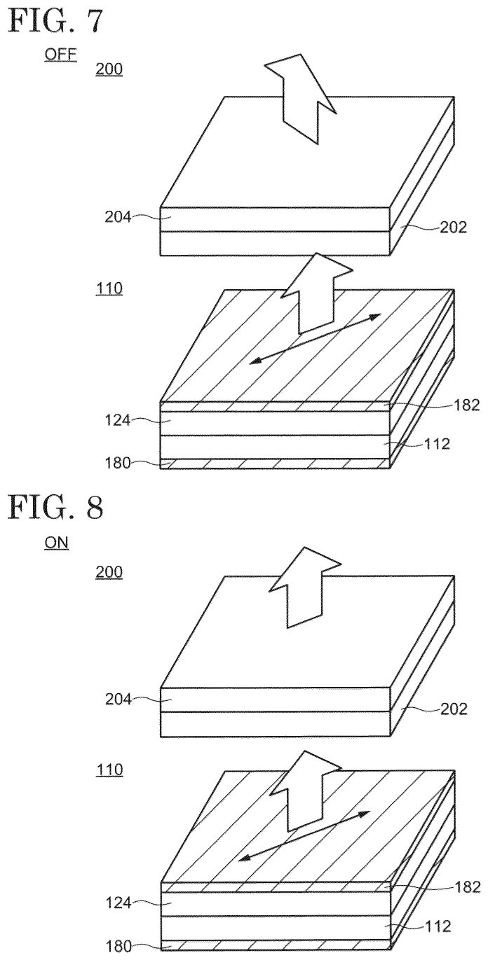

The same is applied when the transmission axis of the second linear polarizer 182 is inclined from a side of the substrate 112. Specifically, the polarization axis of the light emitted from the display device 110 (white arrow) is inclined from a side of the substrate 112 as shown in FIG. 7 by arranging the second linear polarizer 182 so that the transmission axis thereof is inclined from a side of the substrate 112. When the optical element 200 is not driven (OFF), the polarization axis of the light emitted from the optical element 200 is also inclined from this side because the polarization axis of the incident light is rotated by 90° by the optical element 200. When the polarization axis of the light emitted from the display device 110 is inclined 45° from a side of the substrate 112, the polarization axis of the light emitted from the optical element 200 is also inclined 135° from this side. On the other hand, when the optical element 200 is driven (ON), the polarization axis of the light emitted from the optical element 200 (FIG. 8, white arrow) is also inclined from this side because the polarization axis of the incident light is maintained without rotation. When the polarization axis of the light emitted from the display device 110 is inclined 45° from a side of the substrate 112, the polarization axis of the light emitted from the optical element 200 is also inclined 45° from this side.

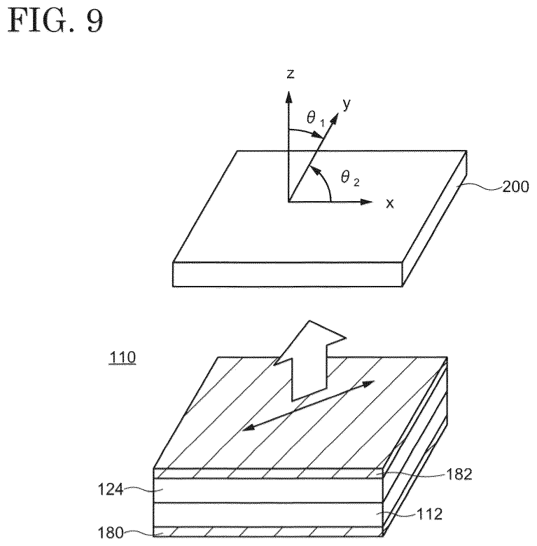

The application of these features described above allows images formed by the light with different polarization states to be acquired and viewed depending on the angle from which the optical system 100 is viewed (i.e., polar angle). This point is explained using FIG. 9 to FIG. 11. In the following explanation, the case in which the polarization axis of the polarized light emitted from the display system 110 is inclined 45° from a side of the substrate 202 as shown in FIG. 9 is used as an example. The directions of two adjacent sides of the substrate 202 are defined as an x-direction and a y-direction, respectively, and the normal direction of the substrate 202 is defined as a z-direction. The polar angle θ₁ is an angle from the z-direction to the y direction, and an azimuth θ₂ is an angle from the x-direction to the y-direction.

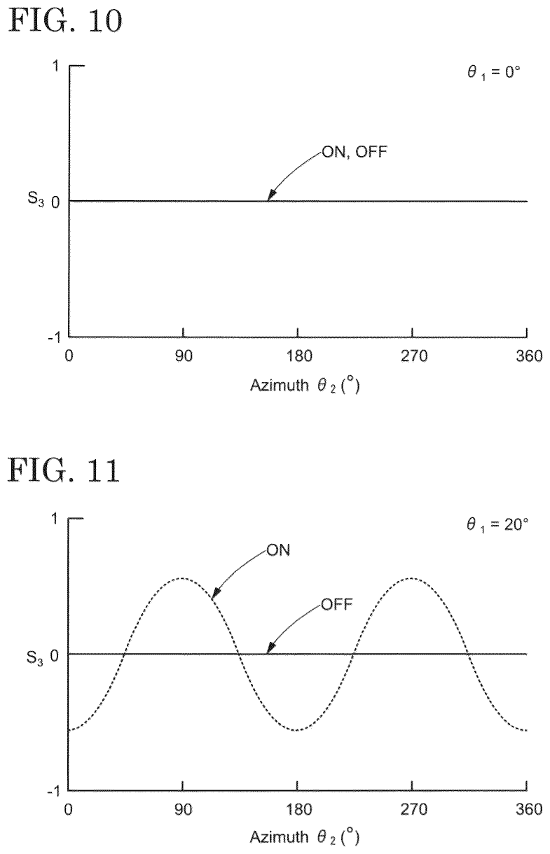

When the display device 110 is driven, red, green, or blue light with controlled gradation is obtained from each pixel 120, and these lights are combined to form an image. This image is formed by the light having a polarization axis inclined by 45° from a side of the substrate 112 or the substrate 202 and is incident on the optical element 200. Here, as schematically shown in FIG. 10, the polarization state of the light observed through the optical element 200 at a polar angle θ₁ of 0° (i.e., frontal to the optical system 100) is almost the same when the optical element 200 is driven and is not driven, and is almost independent on the azimuth θ₂. Specifically, the Stokes parameter S₃ is almost 0 even when the azimuth θ₂ changes and is independent on the azimuth θ₂ so that the light emitted from the optical system 100 is almost linearly polarized.

Even when the polar angle θ₁ deviates from 0° and an image is observed at an angle inclined from the normal of the optical system 100 (e.g., when the polar angle θ₁ is) 20°), linearly polarized light is observed regardless of the azimuth θ₂ as shown in FIG. 11 when the optical element 200 is not driven. In contrast, when the optical element 200 is driven, the polarization state is highly dependent on the azimuth θ₂. Although the light emitted from the optical system 100 is almost linearly polarized when the azimuth θ₂ is approximately 45°, 135°, 225°, and 315°, the light deviates from linear polarization and approaches circular polarization at other angles. In particular, when the azimuth θ₂ is approximately 0°, 90°, 180°, and 270°, the light emitted from the optical system 100 is closest to circular polarized light and becomes elliptically polarized light. That is, the intensity difference between mutually orthogonal polarized lights becomes maximum.

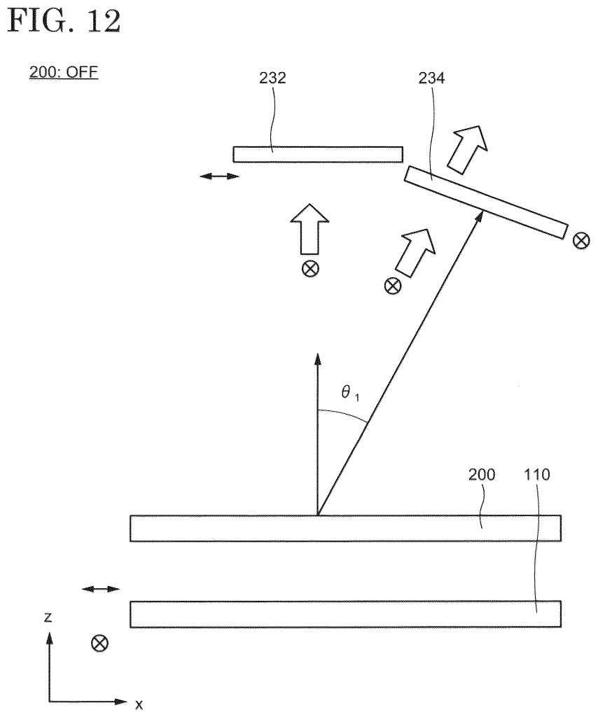

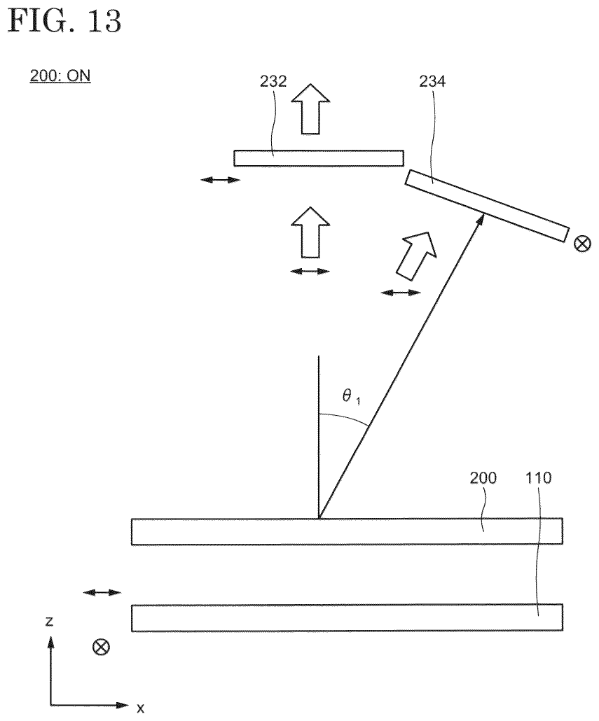

Therefore, it is possible to observe and acquire images formed by the light with different polarization states according to the polar angle θ₁ by switching the optical element 200 on and off in the optical system 100. As described above, since the polarizer for optical selection 232 of the optical shutter 230 is provided so as to be parallel to the display device 110 (see FIG. 4), an image with a polar angle θ₁ of 0° is incident on the polarizer for optical selection 232. As shown in FIG. 12, when the optical element 200 is not driven, the polarization axis of the light incident on the optical element 200 from the display device 110 is rotated by 90° by the optical element 200. Therefore, this image is shielded by the polarizer for optical selection 232 by arranging the polarizer for optical selection 232 so that the polarization axis of the light emitted from the optical element 200 (white arrow) is orthogonal to the transmission axis of the polarizer for optical selection 232 (see solid arrow). On the other hand, the image is incident on the polarizer for optical selection 234 at the polar angle θ₁. Furthermore, the transmission axis of the polarizer for optical selection 234 is orthogonal to the transmission axis of the polarizer for optical selection 232 as described above. Therefore, the light emitted from the optical element 200 can pass through the polarizer for optical selection 234 by arranging the polarizer for optical selection 234 so that the light emitted from the optical element 200 is incident at the azimuth θ₂ at which the Stokes parameter S₃ is minimum or maximum. Therefore, when the optical element 200 is not driven, the image passing through the polarizer for optical selection 234 can be selectively or preferentially acquired.

On the other hand, when the optical element 200 is driven, the polarization axis of the light incident on the optical element 200 is maintained even after passing through the optical element 200 (see the white arrow and the solid arrow thereunder in FIG. 13) so that the polarization axis of this light is parallel to the transmission axis of the polarizer for optical selection 232 (solid arrow). Thus, the image can be acquired through the polarizer for optical selection 232. On the other hand, on the polarizer for optical selection 232 arranged at the apolar angle θ₁, the light having a polarization axis perpendicular to its transmission axis is incident. Therefore, the light emitted through the optical element 200 is shielded by the polarizer for optical selection 234. This mechanism allows the image passing through the polarizer for optical selection 232 to be selectively acquired when the optical element 200 is driven.

In view of the purpose of observing orthogonal polarization states at different polar angles, when considering which polarization state between the driving state and the non-driving state is more advantageous, it is preferable to use the non-driven state when the polar angle θ₁ is not 0 degrees and the driven state when the polar angle θ₁ is 0 degrees.

Note that the it is not always necessary to incline the polarizer for optical selection 234 from the display device 110, and the polarizer for optical selection 234 may be arranged parallel to the display device 110. In this case, it is preferable to arrange the polarizer for optical selection 234 so that the light passing through the optical element 200 is incident at the Brewster angle at which the reflectance of one of the polarized lights is 0.

As described above, the use of the optical system 100 allows images formed by the light with different polarization states to be selectively acquired and viewed. That is, it is possible to selectively acquire and view images formed by the light with linearly polarized light with polarization axes orthogonal to each other. Although not illustrated, the images respectively acquired through the polarizers for optical selection 232 and 234 may be superimposed using a half mirror, polarization beam splitter, or the like by which a plurality of images can be synthesized using a single display device 110.

### Second Embodiment

In this embodiment, modified examples of the optical system 100 described in the First Embodiment are explained. An explanation of the structures the same as or similar to those described in the First Embodiment may be omitted. The following modified examples can be combined with the optical system 100 described in the First Embodiment as appropriate, and the modified examples may also be combined with each other.

### 1. Modified Example 1

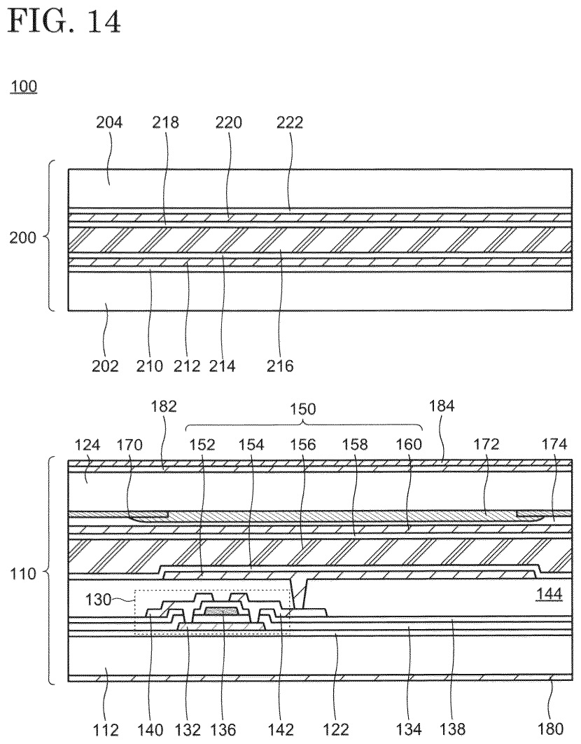

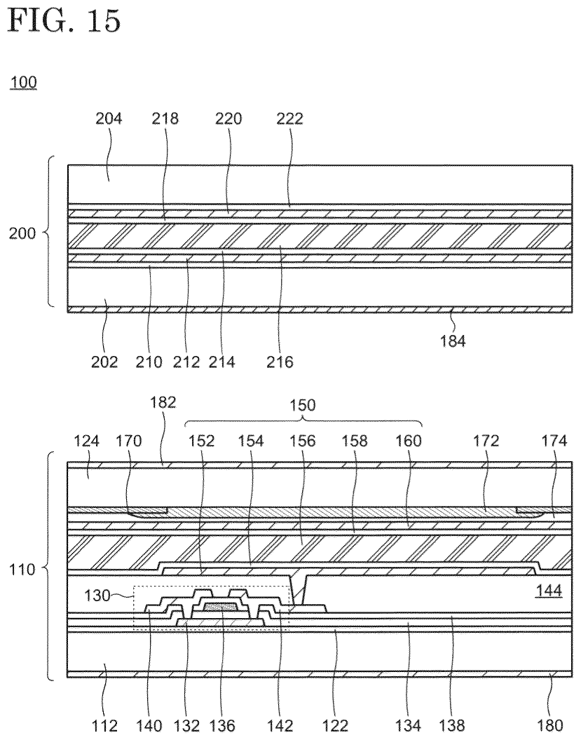

In the optical system 100 described in the First Embodiment, the pair of linear polarizers (first linear polarizer 180 and second linear polarizer 182) is provided to the display device 110. The optical system 100 according to the Modified Example 1 may further be provided with a half-wave plate (½ wave plate). For example, the display device 110 may have a ½ wave plate 184 over the second linear polarizer 182 as shown in FIG. 14. In this case, the adhesive layer 104 securing the display device 110 and the optical element 200 may be in direct contact with the substrate 202 and the ½ wave plate 184. Alternatively, the optical element 200 may have the ½ wave plate 184 under the substrate 202 as shown in FIG. 15. In this case, the adhesive layer 104 may be in direct contact with the second linear polarizer 182 and the ½ wave plate 184.

In the Modified Example 1, the ½ wave plate 184 rotates the polarization axis of the light emitted from the display device 110 by 45°. Thus, when the polarization axis of the light emitted from the display device 110 is parallel to a side of the substrate 202, for example, this light can be incident on the optical element 200 after converting this light to the polarized light with a polarization axis inclined by 45° with respect to this side. Conversely, when the polarization axis of the light emitted from the display device 110 is inclined 45° from a side of the substrate 202, this light can be incident on the optical element 200 after converting this light to the polarized light having a polarization axis parallel to this side.

### 2. Modified Example 2

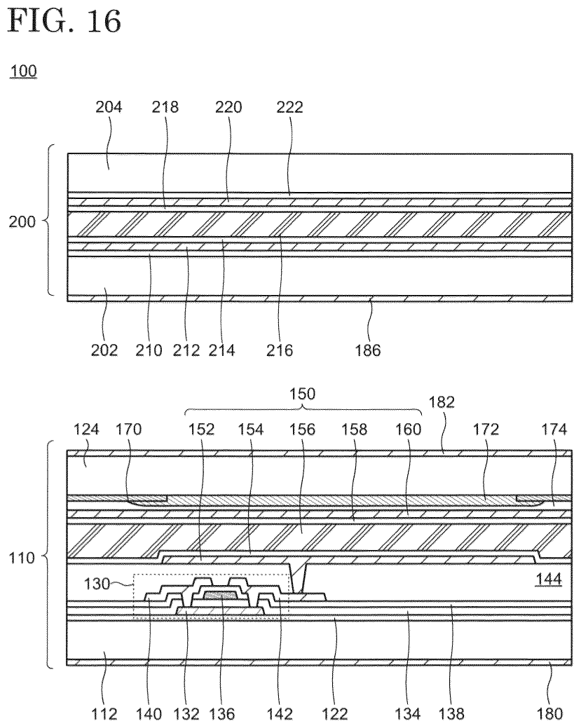

In the optical system 100, a third linear polarizer 186 may further be disposed between the substrate 202 and the counter substrate 124. For example, the third linear polarizer 186 may be provided under the substrate 202 (FIG. 16). In this case, the adhesive layer 104 may be in direct contact with the third linear polarizer 186 and the second linear polarizer 182. The third linear polarizer 186 is arranged so that the transmission axis thereof is parallel to that of the second linear polarizer 182.

As described above, the display 110 and the optical element 200 are fixed to each other by the adhesive layer 104. However, if there is a misalignment during the fixing process, the polarization axis of the light emitted from the display 110 is not necessarily parallel to a side of the substrate 202 or inclined at a predetermined angle (for example,) 45° from this side. However, even if such misalignment occurs, the polarization axis of the light incident on the optical element 200 can be set parallel to a side of the substrate 202 or at a predetermined angle from this side by providing the third linear polarizer 186.

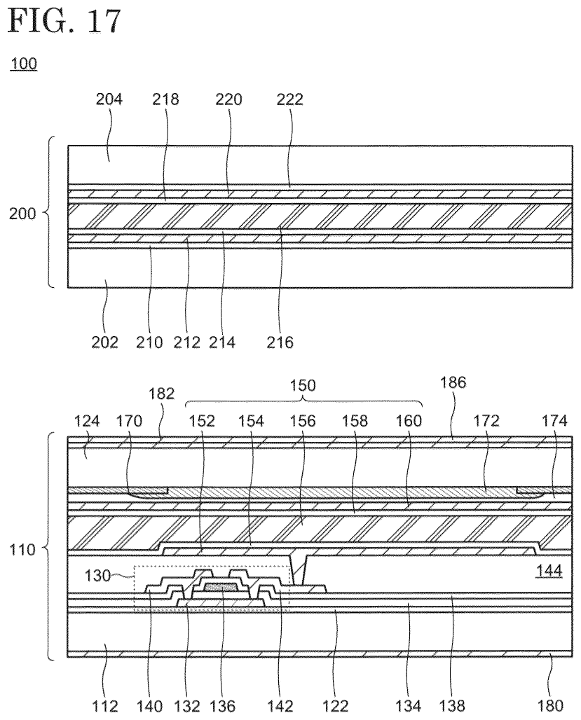

Alternatively, the third linear polarizer 186 may not be provided to the optical element 200 but may be provided to the display device 110 (FIG. 17). In this case, the third linear polarizer 186 is provided over the second linear polarizer 182. The adhesive layer 104 may be in direct contact with the third linear polarizer 186 and the substrate 202.

### 3. Modified Example 3

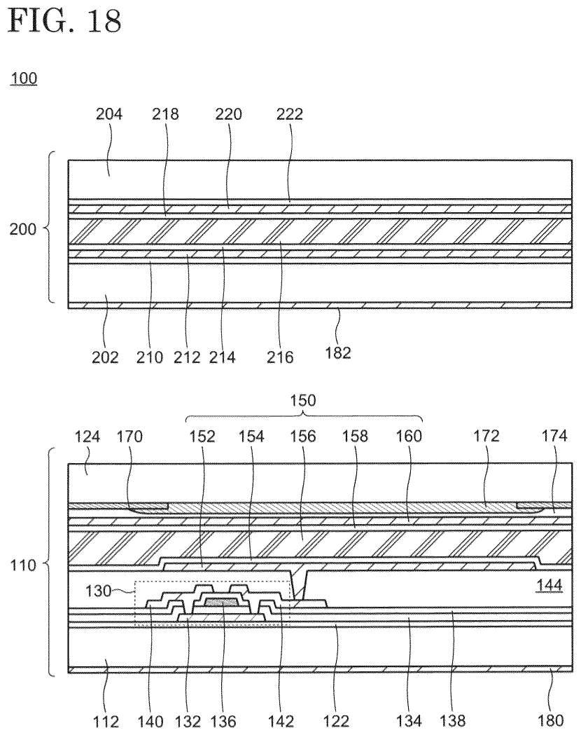

In the optical system 100 described in the First Embodiment, the pair of linear polarizers (first linear polarizer 180 and second linear polarizer 182) is provided to the display device 110. In contrast, in the optical system 100 according to the Modified Example 3, although the first linear polarizer 180 is provided under the substrate 112, the second linear polarizer 182 is not provided to the display device 110 as shown in FIG. 18. The second linear polarizer 182 is provided under the substrate 202 of the optical element 200, by which gradation based on the video signals can be obtained from each pixel 120. The adhesive layer 104 may be in direct contact with the counter substrate 124 and the second linear polarizer 182.

In Modified Example 3, the light incident on the TN liquid crystal element responsible for the optical rotation becomes linearly polarized light through the second linear polarizer 182 located under the substrate 202 so that the switching of the polarization state of the light forming images can also be performed by the optical element 200. Although not illustrated, the third linear polarizer 186 may also be provided in the Modified example 3, similar to the Modified Example 2. The third linear polarizer 186 is provided between the second linear polarizer 182 and the substrate 202. The third linear polarizer 186 may be in direct contact with the second linear polarizer 182.

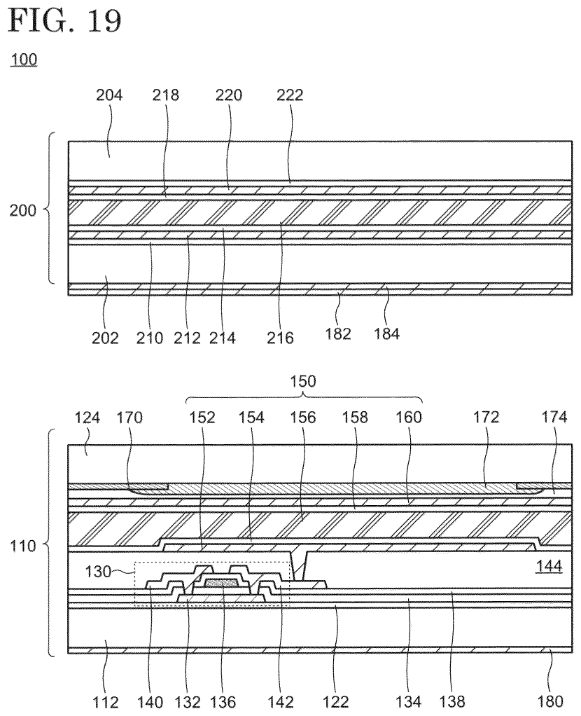

Similar to the Modified Example 1, the ½ wave plate 184 may also be provided in the Modified Example 3. For example, the optical element 200 may have the second linear polarizer 182 and the ½ wave plate 184 sandwiched between the second linear polarizer 182 and the substrate 202 as shown in FIG. 19.

### 4. Modified Example 4

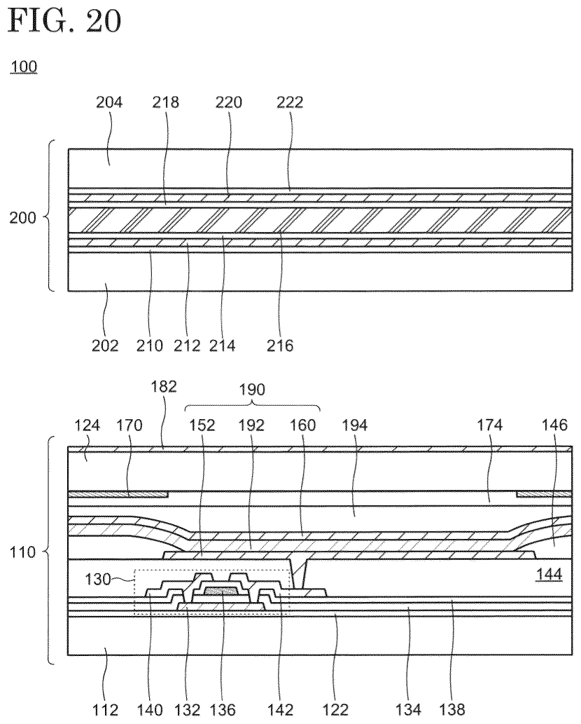

In the display device 110 of the aforementioned optical systems 100, the liquid crystal element 150 is used as the display element. However, the configuration of the display device 110 is not limited thereto, and an electroluminescence element 190 may be used as the display element as shown in FIG. 20. The electroluminescence element 190 is composed of a pixel electrode 152, a common electrode 160 over the pixel electrode 152, and an electroluminescence layer 192 therebetween. An insulating bank 146 containing a polymer such as a polyimide and a polysiloxane resin is provided at the edge of the pixel electrode 152, which prevents the electroluminescence layer 192 from being cut and electrically insulates the adjacent pixels 120. The electroluminescence layer 192 may be composed of a plurality of functional layers containing an organic compound. Known configurations may be applied to the electroluminescence layer 192, and the functional layers such as a charge-injection layer, a charge-transporting layer, a charge-blocking layer, and an emission layer may be combined as appropriate. As an optional component, a sealing film 194 may be provided over the common electrode 160 to protect the electroluminescence element 190. When the electroluminescence element 190 is used as the display element, the backlight 102 is not necessary.

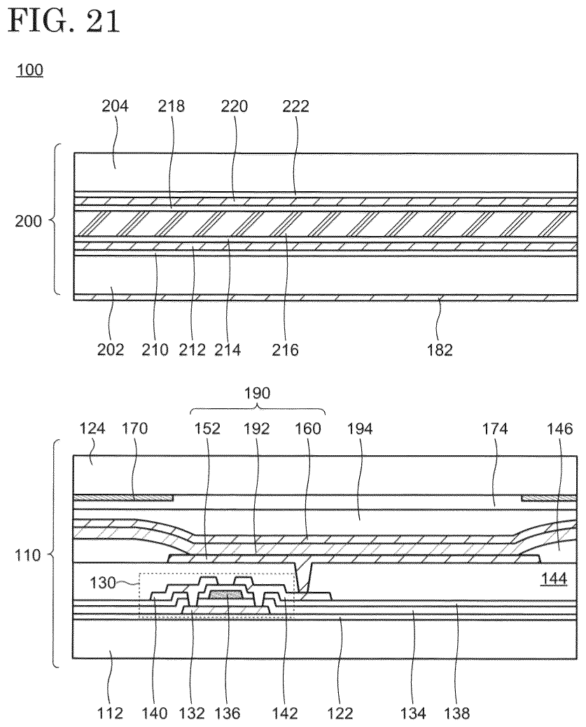

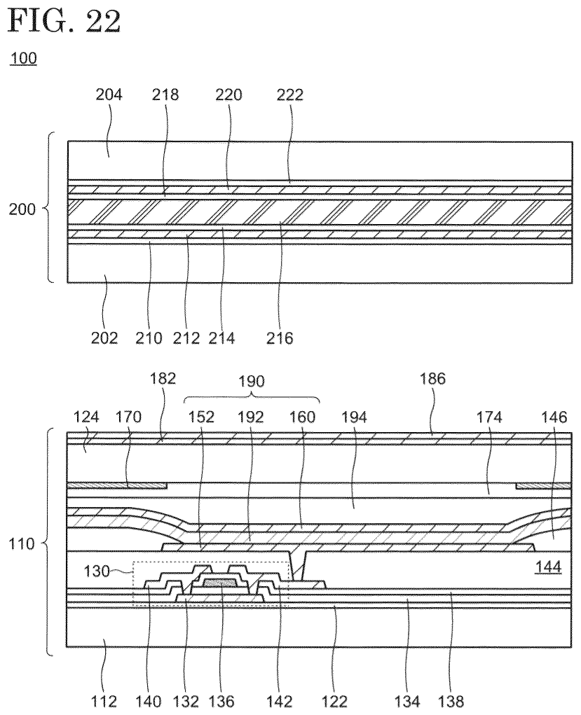

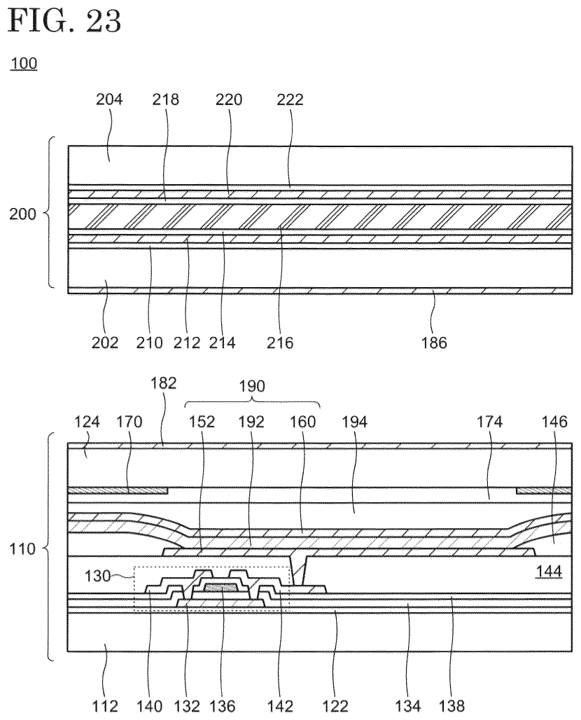

In the display device 110 of the optical system 100 according to the Modified Example 4, it is not necessary to provide the first linear polarizer 180, and the second linear polarizer 182 may be provided over the counter substrate 124. This configuration allows the light emitted from the electroluminescence element 190 to be converted to linearly polarized light and to be supplied to the optical element 200. Alternatively, the second linear polarizer 182 may be provided under the substrate 202 of the optical element 200 without providing the second linear polarizer 182 to the display device 110 (FIG. 21). Alternatively, the third linear polarizer 186 may be placed over the second linear polarizer 182 of the display device 110 in order to prevent defects caused by the misalignment described above (FIG. 22). Alternatively, the second linear polarizer 182 may be placed over the counter substrate 124 of the display device 110, and the third linear polarizer 186 may further be placed under the substrate 202 of the optical element 200 (FIG. 23).

### 5. Modified Example 5

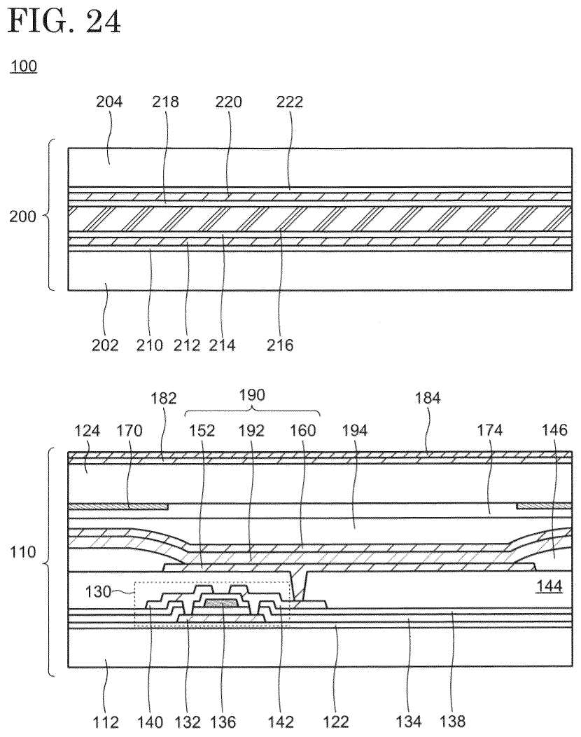

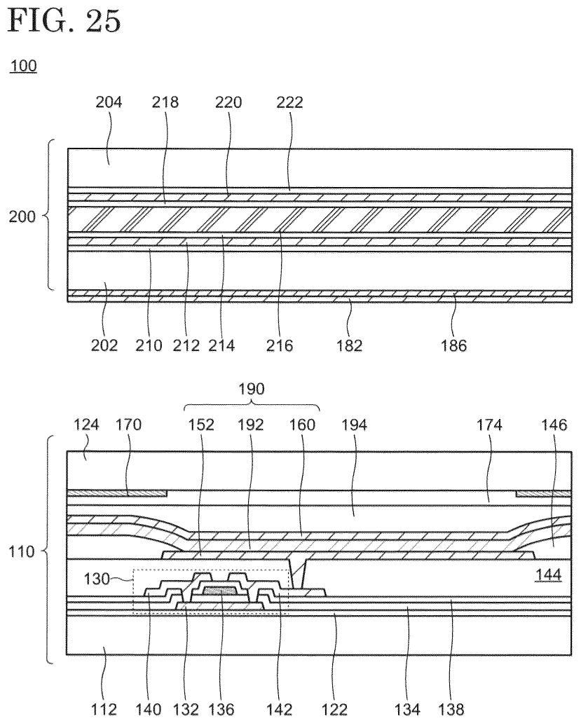

Similar to the Modified Example 1, the ½ wave plate 184 may also be used in the case where the electroluminescence element 190 is used as the display element. For example, the second linear polarizer 182 and the ½ wave plate 184 may be sequentially arranged over the counter substrate 124 of the display device 110 as shown in FIG. 24. Alternatively, no polarizer may be provided to the display 110, while the second linear polarizer 182 may be placed under the substrate 202 of the optical element 200, and the ½ wave plate 184 may be placed between the substrate 202 and the second linear polarizer 182 as shown in FIG. 25.

Similar to the optical system 100 described in the First Embodiment, it is possible to selectively acquire and view images formed by mutually orthogonal linearly polarized lights in any of the aforementioned Modified Examples. It is also possible to synthesize a plurality of images using a single display device 110.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements or through the addition, deletion, or condition change of a process on the basis of each embodiment is included in the scope of the present invention as long as they possess the concept of the present invention.

It is understood that another effect different from that provided by each of the aforementioned embodiments is achieved by the present invention if the effect is obvious from the description in the specification or readily conceived by persons ordinarily skilled in the art.

What is claimed is:

1. An optical system comprising:
a display device;
an optical element located over the display device and configured to transmit light from the display device; and
an optical shutter located over the optical element configured to maintain a polarization axis of the light in a driving state and rotate the polarization axis by 90° in a non-driving state,
wherein the optical shutter comprises a pair of linear polarizers with transmission axes intersecting each other.

2. The optical system according to claim 1,
wherein the display device comprises:
a first linear polarizer;
a liquid crystal element over the first linear polarizer; and
a second linear polarizer over the liquid crystal element, and
the optical element comprises a TN liquid crystal element.

3. The optical system according to claim 2, further comprising a ½ wave plate between the display device and the optical element.

4. The optical system according to claim 1,
wherein the display element comprises:
a first linear polarizer; and
a liquid crystal element over the first linear polarizer,
wherein the optical element comprises:
a second linear polarizer; and
a TN liquid crystal element over the second linear polarizer.

5. The optical system according to claim 4, further comprising a ½ wave plate between the second linear polarizer and the TN liquid crystal element.

6. The optical system according to claim 1,
wherein the display device comprises:
an electroluminescence display device; and
a first linear polarizer over the electroluminescence display device, and
the optical element comprises a TN liquid crystal element.

7. The optical system according to claim 6, further comprising a ½ wave plate between the electroluminescence display device and the optical element.

8. The optical system according to claim 1,
wherein the display device comprises an electroluminescence display device, and
the optical element comprises:
a first linear polarizer; and
a TN liquid crystal element over the first linear polarizer.

9. The optical system according to claim 8, further comprising a ½ wave plate between the first linear polarizer and the TN liquid crystal element.

10. The optical system according to claim 2, further comprising a third linear polarizer between the display device and the optical element,
wherein a transmission axis of the third linear polarizer is parallel to the polarization axis of the light from the display device.

11. The optical system according to claim 4, further comprising a third linear polarizer between the display device and the optical element,
wherein a transmission axis of the third linear polarizer is parallel to the polarization axis of the light from the display device.

12. The optical system according to claim 6, further comprising a third linear polarizer between the display device and the optical element,
wherein a transmission axis of the third linear polarizer is parallel to the polarization axis of the light from the display device.

13. The optical system according to claim 7, further comprising a third linear polarizer between the display device and the optical element,
wherein a transmission axis of the third linear polarizer is parallel to the polarization axis of the light from the display device.

14. The optical system according to claim 1,
wherein the pair of linear polarizers comprises a first polarizer for optical selection and a second polarizer for optical selection,
the first polarizer for optical selection is arranged parallel to the display device, and
the second polarizer for optical selection is arranged so that a normal thereof inclines from a normal of a main surface of the display device.

15. The optical system according to claim 14,
wherein the normal of the main surface of the second polarizer for optical selection and the normal of the main surface of the display device incline from each other by 20°±5°.

16. The optical system according to claim 14,
wherein the first polarizer for optical selection is arranged so that a transmission axis thereof is parallel to a polarization axis of light from the optical element in a non-driving state of the optical element.
